(19) United States
(12) Patent Application Publication
(10) Pub. No.: US 2023/0265253 A1
(43) Pub. Date: Aug. 24, 2023

(54) PROCESSABLE AND PRINTABLE ACRYLIC FILMS AND ARTICLES FORMED THEREFROM

(71) Applicant: Avery Dennison Corporation, Mentor, OH (US)

(72) Inventors: Nicola AVELLA, Oegstgeest (NL); Kyle R. HEIMBACH, Millmont, PA (US)

(21) Appl. No.: 18/172,559

(22) Filed: Feb. 22, 2023

Related U.S. Application Data
(60) Provisional application No. 63/312,550, filed on Feb. 22, 2022.

(51) Int. Cl. C08J 5/18

(52) U.S. Cl. CPC C08J 5/18; C08J 2333/10; C08J 2375/04; C08J 2433/10; C08J 2475/04

(57) ABSTRACT

Films of flexible acrylic polymers in combination with thermoplastic elastomers are disclosed that are conformable like thermoplastic PVC, processable, and printable. Articles comprising these films with adhesive and optional printed indicia and optional liners are also disclosed.

### CROSS REFERENCE TO RELATED APPLICATION(S)

The present application claims priority from U.S. Provisional Application No. 63/312,550 filed Feb. 22, 2022 which is incorporated herein by reference in its entirety.

### FIELD OF THE INVENTION

The present invention generally relates to polymeric films. More particularly, the invention relates to films including polymeric blends that are processable and printable and useful in graphics and related applications.

### BACKGROUND OF THE INVENTION

Graphic articles are used for a number of different purposes including to provide information, for advertising, and for decoration. The graphic articles may include a single layer film or multiple layers of film and an adhesive layer to adhere the graphic films to a substrate. Graphic articles need to be flexible, which enables their attachment to a wide range of surfaces and objects. Some or all of the layers of film may contain images, such as printed images, to generate the graphic pattern or design. In addition, some other properties desirable for the graphic article include good tear resistance and weatherability.

Thermoplastic polyvinyl chloride (PVC) films have been widely used in both indoor and outdoor graphics applications, such as promotional and advertising campaigns, although other polymeric films are also useful. Such applications include signs, banners, fleet graphics, vehicle wrappings, architectural and wall coverings, consumer product labeling, and other pressure sensitive products. They are often used in applications requiring processability, conformability and printability. Unfortunately, PVC-based formulations often result in fogging due to the release of hydrogen chloride (HCI) when they burn. The released HCl fumes and the breakdown of the HCl fumes poses a health hazard. Furthermore, to achieve the soft, conformable characteristics of flexible polyvinyl chloride, a current practice is to formulate the PVC with phthalates, which are associated with health risks. In addition, PVC production typically undesirably requires a vinyl chloride starting material. The vinyl chloride production, as well as incineration of waste PVC, creates harmful dioxins. Accordingly, film compositions are needed that have the characteristics of PVC-based formulations, yet lack PVC and its inherent disadvantages.

Various acrylic resins have been proposed as replacements to PVC. However, many of the acrylic based films are too rigid for certain end applications, or possess poor tear resistance. Multi-stage acrylic polymers, as taught in U.S. Pat. No. 10040915, possess high moduli, and they therefore make processing challenging in certain applications. Some commercial acrylic resins containing block polymers are flexible, but exhibit poor tear resistance. Further, none of these films are inherently printable, and they require a separate printing receptive layer or treatment, such as corona treatment, in order to adequately accept and retain printing inks.

Polyurethane based films have also been proposed in place of PVC. These films are desirable for graphic applications due to their characteristics, such as abrasion resistance, mechanical strength and weatherability. A film sheet of polyurethane can be efficiently prepared by a calendering method. However, the processing temperature range for polyurethane is very small, which leads to difficulties in the continuous production, including low production speed. Further, polyurethane based films are very expensive for end applications. Moreover some these films lack the flexibility required for graphics applications, specifically TPU films having shore D hardness above 65.

There have been alternative polymeric films proposed to replace the PVC films. For example, JP2004039643 discloses a calenderable film containing 100 parts by weight of a thermoplastic polyurethane, 1-40 parts by weight of calcium carbonate having an average particle diameter of 0.3-1.5 µm, and 0.1-1.5 parts by weight of an organic acid metal salt. The patent publication discloses that the thermoplastic polyurethane may be blended with an acrylic soft resin, where the thermoplastic polyurethane is present at a level of 50-95% by weight, and the acrylic soft resin is present at a level of 5-50% by weight. The patent publication states that it is necessary to use calcium carbonate in the specified mean particle size range to prevent blocking and permit easier handling. Furthermore, the patent publication further states that it is necessary to incorporate an organic acid metal salt along with the calcium carbonate in the specified mean particle size range, and that without the combination, there is insufficient improvement in the calendering properties of the polymer composition. However, films with these additives are lacking with respect to printability.

No current offerings seem to address the need for a film that has the conformability, processability and printability of PVC without the inclusion of PVC. The films of the present invention are directed toward these, as well as other, important ends.

### SUMMARY OF THE INVENTION

The invention relates generally to films that are conformable, processable, particularly calenderable, but are still printable, as required for the end use application. In this way, the films of the invention provide an alternative to PVC.

Accordingly, one aspect of the invention is directed to films comprising a polymeric blend, the polymer blend includes 50% by weight to 100% by weight, based on the total weight of the blend, of a flexible acrylic resin; 0% by weight to 50% by weight, based on the total weight of the blend, of a thermoplastic urethane elastomer; 0.1% to 10% by weight, based on the total weight of the blend, of a high molecular weight organic lubricant; and optional pigment, wherein the film is both processable and printable. In some embodiments, the film comprises no more than 1% by weight, based on the total weight of the blend, of filler.

In another aspect, the invention is directed to articles comprising the film described herein, wherein the film has a first face and a second face; an adhesive layer applied to at least a portion of the first face of the film; and optional printed indicia applied to at least a portion of the second face of the film.

The summary of the invention is provided as a general introduction to some of the embodiments of the invention, and is not intended to be limiting. Additional example embodiments, including variations and alternative configurations, of the invention are provided herein.

### BRIEF DESCRIPTION OF THE DRAWINGS

The accompanying drawings, which are included to provide a further understanding of the invention and are incorporated in and constitute a part of this specification, illustrate embodiments of the invention, and together with the description, serve to explain the principles of the invention. In the drawings:

FIG. 1 illustrates an exemplary embodiment of an article containing a representative film of an embodiment of the invention, a pressure sensitive adhesive, optional printed indicia, and an optional release liner.

FIG. 2 illustrates a representative test chart of the film media, when printed on a HP Latex Gen III used in the Chroma Test in the Examples.

FIG. 3 illustrates a representative swatch book used in the Chroma Test in the Examples.

FIG. 4 illustrates a representative two-dimensional chart of the C value (area) used in the Chroma Test in the Examples.

### DETAILED DESCRIPTION OF THE ILLUSTRATIVE EMBODIMENTS

### Definitions

As employed above and throughout the disclosure, the following terms, unless otherwise indicated, shall be understood to have the following meanings.

As used herein, the terms “comprises,” “comprising,” “includes,” “including,” “has,” “having” or any other variation thereof, are intended as open-ended, and cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” is employed to describe elements and components described herein. This is done merely for convenience and to give a general sense of the scope of the invention. This description should be read to include “one” or “at least one,” and the singular also includes the plural, unless it is obvious that it is meant otherwise by the context. As used herein, the term “about,” when referring to a measurable value such as an amount, a temporal duration, and the like, is meant to encompass variations of ±10%, preferably, ±8%, more preferably, ±5%, even more preferably, ±1%, and yet even more preferably, ±0.1% from the specified value, as such variations are appropriate.

As used herein, “pressure sensitive adhesive” or “PSA” refers to a material that may be identified by the Dahlquist criterion, which defines a pressure sensitive adhesive as an adhesive having a one second creep compliance of greater than 1- 1×10⁻⁶ cm²/dyne as described in Handbook of PSA Technology, Donatas Satas (Ed.), 2^{nd} Edition, page 172, Van Nostrand Reinhold, New York, N.Y., 1989. Since modulus is, to a first approximation, the inverse of creep compliance, pressure sensitive adhesives may also be defined as adhesives having a Young’s modulus of less than 1×10⁶ dynes/cm². Another well-known means of identifying a pressure sensitive adhesive is an adhesive that it is aggressively and permanently tacky at room temperature and firmly adheres to a variety of dissimilar surfaces upon mere contact, without the need of more than finger or hand pressure, and which may be removed from smooth surfaces without leaving a residue, as described in Glossary of Terms Used in the Pressure Sensitive Tape Industry provided by the Pressure Sensitive Tape Council, 1996. Another suitable definition of a suitable pressure sensitive adhesive is that it preferably has a room temperature storage modulus within the area defined by the following points as plotted on a graph of modulus versus frequency at 25° C.: a range of moduli from about 2×10⁵ to 4×10⁵ dynes/cm² at a frequency of about 0.1 radians/sec (0.017 Hz), and a range of moduli from about 2×10⁶ to 8×10⁶ dynes/cm² at a frequency of approximately 100 radians/sec (17 Hz). See, for example, Handbook of PSA Technology (Donatas Satas, Ed.), 2^{nd} Edition, page 173, Van Nostrand Rheinhold, N.Y., 1989. Any of these methods of identifying a pressure sensitive adhesive may be used to identify suitable pressure sensitive adhesives for use in the film constructions of the invention.

As used herein, a “glass transition temperature” or “T_{g}” of a copolymer refers to the glass transition temperature as calculated with the Fox equation [Bulletin of the American Physical Society 1, 3 Page 123 (1956)] as follows (wherein the copolymer contains two monomers):

$$1 / {\text{T}}_{\text{g}} = {\text{w}}_{1} / {\text{T}}_{\text{g1}} + {\text{w}}_{2} / {\text{T}}_{\text{g2}}$$

For a copolymer, w₁ and w₂ refer to the weight fraction of the two comonomers, based on weight of monomers charged to the reaction vessel, and T_{g1} and T_{g2} refer to the glass transition temperatures of the two corresponding homopolymers in degrees Kelvin. For polymers containing three or more monomers, additional terms are added (w_{n/}T_{g}(ₙ)). The glass transition temperatures of homopolymers for the purposes of this invention are those reported in “Polymer Handbook”, edited by J. Brandrup and E. H. Immergut, Interscience Publishers, 1966, unless that publication does not report the T_{g} of a particular homopolymer, in which case the T_{g} of the homopolymer is measured by differential scanning calorimetry (DSC) at a heating rate of 10°K/minute.

As used herein, the term “film” refers to an object that has one dimension (thickness) that is relatively small compared to the other two dimension (length and width). The thickness of a film is 0.01 mm to 2 mm. The length and width of a film are each 1 cm or greater. The surface of a film defined by its length and width is known herein as the “face” of the film (or as a first face and second face).

As used herein, the term “adhesive layer” means a layer or multiple layers of the same or different pressure sensitive adhesives applied to at least a portion of the first face of the films of the invention.

As used herein, the term “release liner” means film sheet (typically paper or polymeric film, usually applied during the manufacturing process) used to prevent a sticky surface from prematurely adhering. It is coated on one or both sides with a release agent, which provides a release effect against any type of a sticky material, such as an adhesive or a mastic.

As used herein, the term “printed indicia” means any string of alphanumeric or special characters used to convey information (such as name, residence or mailing address, telephone number, prescription number, and the like) and/or provide aesthetic appeal. The indicia may be printed by any suitable means including printing by hand, typewriter, or conventional printing (such as flexographic printing, offset printing, inkjet printing, laser inkjet printing, videojet printing, thermal transfer, direct printing, gravure printing, digital printing and the like).

As used herein, the term “flexible acrylic resin” or “FAR” refers to a (meth)acrylic polymer (preferably, an all (meth)acrylic polymer) that has a flexibility similar to plasticized PVC at room temperature, i.e., an elasticity modulus of between 0.001 GPa and 1.8 GPa, when measured in accordance with ASTM D882-18 (at a rate of 5 inches/minute). The FAR contains the polymerized residues of at least two types of (meth)acrylate monomers, where one has a high glass transition temperature (preferably, above 25° C. as measured by differential scanning calorimetry in accordance with ASTM-D3418-21) and one has a low glass transition temperature (preferably, below 20° C. as measured by differential scanning calorimetry in accordance with ASTM-D3418-21). The FAR may contain minor amounts of other monomers, particularly (meth)acrylate monomers, such as meth(acrylic) acid. The FAR may be in the form of a variety of polymer structures and morphologies, such block copolymers and core-shell or multilayer polymer particle. For example, the FAR may be a core-shell or multilayer acrylic polymer particle prepared by a sequential emulsion polymerization process, such as the process described in US-B-10,040,915 and WO 2020/197797, the entire disclosures of which are incorporated herein by reference.

As used herein, the prefix “(meth)acryl-” refers to both “methacryl-” and “acryl-”, such as in “(meth)acrylic” (meaning both methacrylic and acrylic), “(meth)acrylate” (meaning both methacrylate and acrylate), and “(meth)acrylonitrile” (meaning both methacrylonitrile and acrylonitrile). The term “(meth)acrylate” refers to monomeric acrylic or methacrylic esters of alcohols. Acrylate and methacrylate monomers are referred to collectively herein as “(meth)acrylate” monomers. Polymers prepared from (meth)acrylate monomers are referred to as (meth)acrylate polymers.

As used herein, the term “acrylic polymer” refers to at least one (meth)acrylate homopolymer or copolymer and may include a blend of different (meth)acrylate polymers and copolymers.

As used herein, the term “polymer” will be understood to include polymers, copolymers (e.g., polymers formed using two or more different monomers), oligomers, and combinations thereof.

The term “copolymer” is used herein to refer to polymers containing copolymerized units of at least two different monomers.

As used herein, the term “ethylenically unsaturated”, when used to described monomers or groups, refers to monomers or groups that contain terminal ethylene groups (H₂C═CH—).

As used herein, “gsm” means grams per square meter.

As used herein, “Shore Hardness” is a standardized measurement of the hardness of a material measured with a durometer with a dimensionless output on a scale from 0-100 (where higher measurements indicate harder materials), in accordance with ASTM D2240-15 (2021) and ISO 868:2003 (2018). A measurement of 80 on the Shore Hardness A scale is equivalent to a measurement of 29 on the Shore Hardness D scale.

As used herein, “conformable” means a film capable of substantially conforming to an underlying surface to which it is applied, so that the exposed surface of the conformable film mimics the topology of the underlying surface.

As used herein, “metal detachment” is an assessment for processability. To evaluate metal detachment, a material or a blend of materials is heated under pressure of a metal two roll mill, under the conditions set forth in the Examples. After complete fusion of the material, the gap is set to the lowest value that allows film, which typically is around 50 mµ, but may vary depending on the rheology of material. The speed for sampling is reduced (for example, to 20 rpm of cylinder) to one to allow manual detachment. Manual detachment of the film from the metal surface of the rolls is subjectively judged based on:
Ease of detachment (manual force needed to detach), and Position of detachment line; and
Rated as 3 = good/acceptable, 2 = OK/acceptable, and 1 = bad/not acceptable.

As used herein, “printability” means the ability of a film to be printed with ink to form printed indicia such that it meets the requirement of a chroma area of at least 99 as measured by the Chroma Area assessment described in the Examples.

As used herein, “roll blocking” means the defects in a film or film construction caused when adjacent films or film constructions fuse or adhere together, and which may be observed when the film or film construction is unwound from a roll. Blocking may be assessed using the T-Peel test (in N/in) as described in the Examples and rated as ≤1.25 = acceptable (roll blocking is prevented), >1.25 = bad/not acceptable (roll blocking is not prevented).

All percentages noted herein are percentages by weight, based upon the weight of the composition, unless indicated otherwise.

The invention relates generally to films, especially thin films that are processable and calenderable. The films provide an alternative to PVC, as they provide the properties desirable for graphic articles, including for example, good tear resistance and weatherability. In some embodiments, the films are at least as conformable as PVC, substantially as conformable as PVC, or conformable like PVC. Advantageously, the films do not suffer from the health risks associated with PVC films; the poor conformability, tear resistance and printability of conventional acrylic films; and the lack of conformability of polyurethane films. Accordingly, the films are suitable for a variety of end-uses. The invention will be described in further detail with respect to the films as well as the articles comprising the films.

The films are processable through melt methods, such as for example, extrusion, blowing, and particularly calendering. The calenderability of the film can be measured by the ease of metal detachment of the film. The method for evaluating metal detachment is described hereinabove. Alternatively, calenderability can be evaluated by the ease of unwinding the film from a roll, without causing defects, or without causing substantial defects (also known as prevention of roll blocking), especially without a carrier. In addition to being processable, the film is also printable.

In some embodiments, the films have a thickness of from 0.01 mm to 2 mm, from 30 µm to 200 µm, from 50 µm to 150 µm, or from 80 µm to 120 µm.

Accordingly, some embodiments of the invention are directed to films comprising a polymeric blend. The polymer blend comprises 50% by weight to 100% by weight, based on the total weight of the blend, of a flexible acrylic resin; 0% by weight to 50% by weight, based on the total weight of the blend, of a thermoplastic urethane elastomer; 0.1% to 10% by weight, based on the total weight of the blend, of a high molecular weight organic lubricant; and optionally contains a pigment. As noted hereinabove, the film is both processable and printable. The film is characterized with a viscosity in the range of from 1,000 Pa.s to 150,000 Pa.s at 170° C. and at 10 rad/s.

In certain embodiments, the flexible acrylic resin is present at a level of from 50% by weight to 100% by weight, or from 50% by weight to 95% by weight, based on the total weight of the blend. All individual values and sub-ranges are disclosed herein and included herein; for example, the amount of the flexible acrylic resin may be from a lower limit of 50, 55, 60, 65, or 70 weight percent to an upper limit of 75, 80, 85, 90 or 95 weight percent. For example, the amount of the flexible acrylic resin may be in the range of from 50 to 95 weight percent, or in the alternative, from 60 to 90 weight percent, or from 65 to 85 weight percent, or from 70 to 80 weight percent, or from 50 to 60 weight percent, or from 50 to 70 weight percent.

In some embodiments, the flexible acrylic resin has a Shore D Hardness of from about 40 to about 60, from about 45 to about 55 or from about 50 to about 60. By “Shore D Hardness” is meant herein a standardized test involving measuring the depth of penetration of a specific indenter. The hardness value is determined by the penetration of the Durometer indenter foot into the sample.

Any suitable flexible acrylic resin can be used. In some embodiments, the flexible acrylic resin is a block polymer. In some embodiments, the flexible acrylic resin is a multi-stage polymer. In some embodiments, the flexible acrylic resin is a block copolymer, a multi-stage polymer, or both. In some embodiments, the flexible acrylic resin is block copolymer prepared from Poly(methyl methacrylate) (PMMA) and butyl acrylate (BA). In certain embodiments, the flexible acrylic resin is an ABA type block copolymer. In some embodiments, the ABA type block copolymer is prepared from Poly(methyl methacrylate) (PMMA) and butyl acrylate (BA). In some embodiments, the flexible acrylic resin comprises a multi-stage acrylic polymer. In some embodiments, the multi-stage acrylic polymer comprises a core layer comprising the crosslinked residues of a low Tg monomer; an optional intermediate layer; and a shell layer comprising a methacrylate polymer having a glass transition temperature above 100° C. In some embodiments, the low Tg monomer is selected from butyl acrylate, 2-ethylhexyl acrylate, or both. In some other embodiments, the flexible acrylic resin does not contain the hydrogen-bondable monomer.

In some embodiments, the polymer blend includes a urethane polymer that is thermoplastic. The thermoplastic urethane elastomer (also known as a thermoplastic polyurethane, thermoplastic urethane polymer or TPU) is a reaction product of polyisocyanates with polyols, and sometimes also with polyamines.

Polyisocyanates are compounds with two or more isocyanate groups per molecule. Any suitable polyisocyanate can be used, such as for example, aromatic diisocyanates, aromatic-aliphatic diisocyanates, cycloaliphatic diisocyanates, polymeric or oligomeric compounds (such as, for example, polyoxyalkylene, polyester, polybutadiene, and the like, terminated by two or more isocyanate functional groups), and combinations thereof. Suitable Polyols are molecules with two or more hydroxyl groups per molecule. Suitable polyols include, for example, polyether polyols, polyester polyols, polycarbonate based polyol, polyethylene glycols and mixtures thereof. Polyamines are compounds with two or more amine groups per molecule. The polyamine or polyamines, if any is present, may be aliphatic polyamines or aromatic polyamines or a mixture thereof.

Suitable TPUs may be any type of TPU. For example, suitable TPU’s may be aliphatic TPU’s, aromatic TPU’s, or TPU’s that contain at least one aliphatic component and at least one aromatic component. In some embodiments, one or more TPU of the present invention is aliphatic. In an aliphatic TPU, each polyisocyanate, polyol, and (if used) polyamine is aliphatic. “Aliphatic” herein means linear aliphatic, branched aliphatic, cyclic aliphatic, or mixtures thereof. In some embodiments, one or more TPU of the present invention is aromatic. An aromatic component is a component that contains one or more aromatic ring. In an aromatic TPU, at least one of the polyisocyanate, polyol, and (if used) polyamine is aromatic. “Aromatic” herein includes linear aromatic, branched aromatic, or mixtures thereof.

In some embodiments, the polymer blend includes a polyether based thermoplastic polyurethane. In some embodiments, the polymer blend includes a polyester based thermoplastic polyurethane. In some embodiments, the polymer blend includes a polycarbonate based thermoplastic polyurethane. In some embodiments, the polymer blend includes at least one of a polyether based polyurethane, polyester based polyurethane, or polycarbonate based polyurethane. The thermoplastic urethane elastomer, when present, has a Shore D Hardness of from about 55 to about 95, from about 60 to about 90, or from about 65 to about 85, or from about 70 to about 80, or from about 60 to about 70. In some embodiments, the thermoplastic urethane elastomer has a Shore D Hardness of at least 65.

In certain embodiments, the thermoplastic urethane elastomer is present at level of from 0% by weight to 50% by weight, based on the total weight of the blend, or at a level of from 5% by weight to 50% by weight, based on the total weight of the blend. All individual values and sub-ranges are disclosed herein and included herein; for example, the amount of thermoplastic urethane elastomer may be from a lower limit of 0, 1, 5, 10, 15, 20, 25, 30 or 35 weight percent to an upper limit of 25, 30, 35, 40, 45, or 50 weight percent. For example, the amount of the thermoplastic urethane elastomer may be the range of from 0 to 50 weight percent, or in the alternative, from 5 to 50 weight percent, or from 10 to 40 weight percent, or from 20 to 30 weight percent, or from 30 to 50 weight percent, or from 40 to 50 weight percent.

The polymer blend further includes a high molecular weight organic lubricant. It was unexpectedly found that the high molecular weight organic lubricant improves the processability of the polymer blend, particularly in the calendaring process. In certain embodiments, the high molecular weight organic lubricant is a high molecular weight polyester lubricant. By “high molecular weight” is meant herein having a molecular weight of at least 1,500 Da. In some embodiments of the invention, the molecular weight of the lubricant is in the range of from 1,500 Da to 50,000 Da. The high molecular polyester is the reaction product of a fatty acid and an alcohol. In certain embodiments, the high molecular polyester is the reaction product of a fatty acid selected from oleic acid, stearic acid, hydroxystearic acid, or any combination thereof; and an alcohol selected from butanol, octanol, glycerol, pentaerythritol, or any combination thereof. In some embodiments, the high molecular weight polyester is the reaction product of oleic acid and n-octanol. In some embodiments, the high molecular weight polyester is the reaction product of stearic acid and n-butanol. In some embodiments, the high molecular weight polyester is the reaction product of a fatty acid and glycerol. Surface migration of lubricants degrades the quality of polymer composites, specifically it impacts the printing performance. High molecular weight organic lubricant, as included in the present invention, exhibit lower migration towards the surface of the film prepared from the polymer blend.

In some embodiments, the high molecular weight organic lubricant is present in an amount in the range of from 1% to 10% by weight, from 1% to 5% by weight, from 2% to 4% by weight, or from 3% to 4% by weight, based on the total weight of the blend. Polymer blends including lubricant outside the claimed range renders the film non-processable, or negatively affect the printing quality of the film.

In certain embodiments, the polymer blend further includes a pigment. Pigment is an organic or inorganic compound, which is added to the polymer base to give a specific color or functional benefits. In some embodiment, the pigment is at least one compound selected from the group consisting of phthalocyanine blue, ultra-marine, barium sulphate-permaganate, carbon black, antimony titanate, cobalt titanate, iron oxide, titanium dioxide, benzimidazolone, perylene, pyrathrone, pyrazo quinazo, quinacridone, quinophthalone, zirconium vanadium, nickel niobium titanium, and isoindoline. In preferable embodiment, the pigment is a white pigment, such as for example, titanium dioxide.

In some embodiments, the film comprises no more than 1% by weight, based on the total weight of the blend, of a filler. “Filler’ is meant herein to be an organic or inorganic compound that is introduced into a polymeric composite or blend in order to change or modify the properties of the polymeric composite or blend, such as, for example, calcium carbonate. In some embodiments, the film comprises less than 0.75% by weight, based on the total weight of the film, of a filler. In some embodiments, the film comprises less than 0.75% by weight, based on the total weight of the film, of calcium carbonate. In certain preferred embodiments, the film does not contain a filler. In certain preferred embodiments, the film does not contain calcium carbonate. The addition of high amounts of filler, typically more than 1% by weight, of total weight of the polymeric blend, results in poor calenderability and poor print performance.

In some embodiments of the invention, the film comprises less than 0.075% by weight, based on the total weight of the film, of an organic acid metal salt. In certain embodiments, the organic acid metal salt is a salt selected from the group of barium stearate, zinc stearate, and combinations thereof. In certain other embodiments, the film comprises less than 0.75% by weight, based on the total weight of the film, of calcium carbonate; and less than 0.075% by weight, based on the total weight of the film, of organic acid metal salt. In certain embodiments, the film does not contain an organic acid metal salt.

The best balance of processability, particularly in calendaring and conformability of the film at room temperature is achieved by tuning the hardness of the polymeric blend of TPU, flexible acrylic resin and high molecular weight organic lubricant. A combination of a soft TPU and a soft acrylic will result in a film which may be conformable, but it will not be processable, and possibly it may be tacky, which leads to blocking. A combination of a hard TPU and a hard acrylic will lead to a film which can be processable but will be brittle at room temperature and not conformable. Either choosing a soft TPU with a hard acrylic, or a hard TPU with a soft acrylic, likely will result in a mixture that will process well and be conformable at room temperature. The addition of high molecular weight organic lubricant further improves the processability and printability performance of the film. Not to be bound by theory, the specific polymer blend of the invention provides a film which is conformable, calenderable and printable.

In certain embodiments, the film is calendered with or without a casting or interleaf sheet, such as described in US-B-6,520,235, which is incorporated herein by reference in its entirety. In certain embodiments, the film is extruded with or without a casting or interleaf sheet.

In some embodiments, the invention is directed to articles, comprising the film described herein. The film may be a single film layer or two or more layers of film. The film has a first face and a second face. An adhesive layer is applied to at least a portion of the first face of the film. The adhesive layer may be applied to the first face of the film by any suitable means. In some embodiments, the adhesive layer is a pressure sensitive adhesive layer. Optionally, a printed indicia is applied to at least a portion of the second face of the film. As is noted above, the printed indicia may be applied to the film by any suitable means.

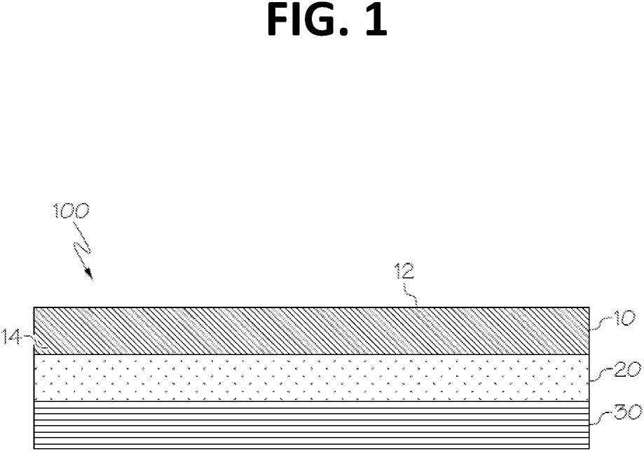

FIG. 1 illustrates an article as described herein. The article 100 includes the film of the invention as a facestock layer 10, pressure sensitive adhesive layer 20, and optional release layer 30, as described herein (and not shown to scale). The facestock layer 10 defines a first side 12 and an oppositely directed second side 14. The facestock layer is shown as a single layer but may be multilayer. The pressure sensitive adhesive layer 20 is applied over at least a portion of the second side 14. The pressure sensitive adhesive layer is shown as a single layer but may be multilayer.

The present invention is further defined in the following Examples, in which all parts and percentages are by weight, unless otherwise stated. It should be understood that these examples, while indicating certain embodiments of the invention, are given by way of illustration only. Further it will be understood that the embodiments of the invention are combinable. From the above discussion and these examples, one skilled in the art can ascertain the essential characteristics of this invention, and without departing from the spirit and scope thereof, can make various changes and modifications of the invention to adapt it to various usages and conditions.

### EXAMPLES

The following test methods were used to evaluate exemplary embodiments and comparative materials, unless otherwise noted.

### Metal Detachment

To measure metal detachment, material is melted between a two roll mill set as follows:
Cylinder one is set at a speed of 50 rpm and a temperature of 165° C.
Cylinder two is set at a speed 40 rpm and a temperature of 163° C.
Gap set at 100 mµ is considered gap 0.

After complete fusion of the material, the gap is set to the lowest value that allows film around 50 µm depending on the rheology of material. The speed for sampling is reduced to 20 rpm of cylinder to one to allow manual detachment. Manual detachment is subjectively judged based on:
Easy of detachment (manual force needed to detach); and
Position of detachment line.

### Chroma Area

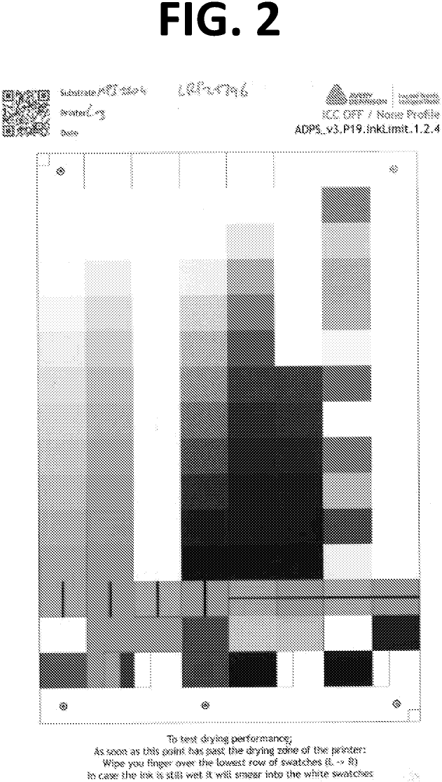

This test is used to quantify the overall color quality of a unique printer, ink, print settings, and media combination utilizing all inks in the printer. Where chromaticity is normally measured per color, the Chroma Area method quantifies the overall performance, and simplifies the comparison of media. The film media is printed on a HP Latex Gen III (manufactured by HP Inc., headquartered in Palo Alto, CA) using a test chart, as shown in FIG. 2, with profile setting as follows:
A. No Ink limits
B. No Linearization
C. International Color Consortium (ICC) OFF

The test chart, as shown in FIG. 2 is acquired using Qi image quality (QiQ) Scanning. Each block in the test chart represents a different color. The test chart demonstrates how different colors, including different intensities of the same color, print clearly on the film. As can be seen from the test chart the main printing colors of black (K), cyan (C), magenta (M) and yellow (Y) print well, as do several combinations of each of these colors.

The Chroma Area is measured as:

$$C = \sqrt{{a}^{2} + {b}^{2}}$$

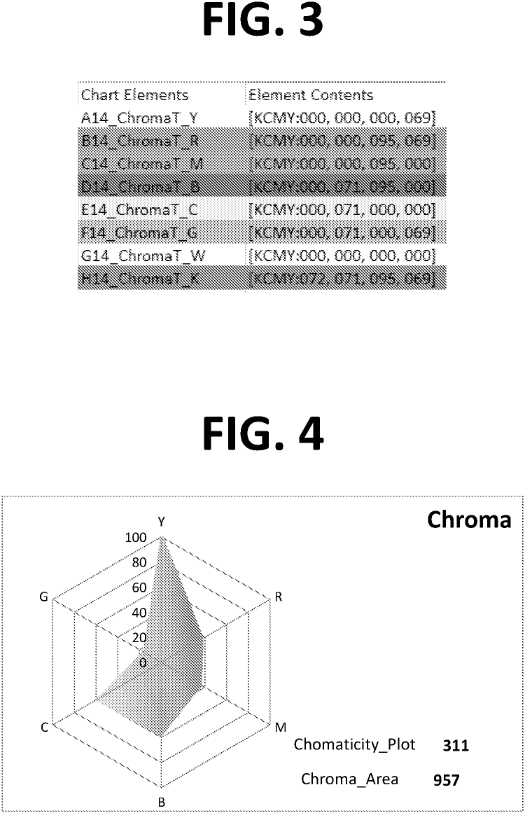

of a specific portion of the swatch book, as shown in FIG. 3. Chroma Area is the area of a plot on two dimensional chart of the C value, as shown in FIG. 4. As a reference, PVC scores, for example, Chroma Area = 123.

FIG. 3. Illustrates a representative swatch book used in the Chroma Test. Each line in the chart represents a different swatch color, as follows:
A14-ChromaT-Y = yellow
B14_ChromaT-R = red
C14_ChromaT-M = magenta
D14_ChromaT-B = blue
E14_ChromaT-C = cyan
F14_ChromaT-G = green
G14_ChromaT-W = white
H14_ChromaT-K = black

Each printer includes inks in the colors black (K), cyan (C), magenta (M) and yellow (Y). Accordingly, the element content of each color in the swatch chart (KCMY) is shown in the right hand column of the chart.

FIG. 4 illustrates a representative two-dimensional chart of the C value (area) used in the Chroma Test in the Examples. Each color in the chart represents a different color (or combinations of colors), as shown in the swatch book representation of FIG. 3, and described hereinabove.

### T-Peel

T-Peel is used as a measure of the propensity of a film or film construction to roll block, which are defects in the film or film construction caused when adjacent films or film constructions fuse or adhere together, and which may be observed when the film or film construction is unwound from a roll. For the examples, T-peel is measured according to Féderation Internationale des fabricants et transformateurs d′Adhésifs et Thermocollants sur papiers et autres supports (FINAT) Standard Test FTM-1 (2019). A sample is prepared on two roll mill as per the Metal Detachment test, and then is folded on itself on the glossy side with a siliconized PET stripe as interleaf. The sample is placed in a Labtech press (manufactured by Labtech Engineering Company Ltd, headquartered in Thailand) for 100 hours at 40° C. and a pressure of 1 MPa to simulate layer-on-layer pressure in roll form. The sample is then cooled for a minimum of 2 hours at 20° C., before removing the sample from the press. The prepared samples are conditioned at 50% relative humidity at room temperature for 4 hours. The peel force is measured on a tensile tester according to FINAT Standard Test FTM-1 (2019). The data in the Examples is reported as an average force of three repetitions, expressed in N/inch.

The testing results are shown in the tables below, where:
Processability is assessed using metal detachment and rated as 3 = good/acceptable, 2 = OK/acceptable, and 1 = bad/not acceptable.
Printability is assessed using chroma area and rated as >199 = good/acceptable, 99-199 = OK/acceptable, and <99 = bad/not acceptable.
Blocking is assessed using the T-Peel test (in N/in) and rated as <1.2 5= acceptable, >1.25 =b ad/not acceptable.

For a given example, the flexible acrylic resins and TPUs are presented as a weight percent, based on the total weight of the polymer blend. The other components are presented as parts per 100 parts polymer blend. All of the examples of the invention formed conformable films.

TABLE 1

Impact of acrylic -TPU blend and lubricant

| Example No. {“c” indicates comparative example) | 1C | 2C | 3C | 4C | 5C | 6C | 7C | 8C | 9 | 10 | 11 | 12 |
|---|---|---|---|---|---|---|---|---|---|---|---|---|
| Flexible Acrylic Resin Acrylic core-shell polymer | 100 | 75 | 25 | 50 | 50 | 50 | 75 | 25 | 50 | 50 | 50 | 75 |
| TPU (shore D hardness of 93) | | | | 50 | | | | | 50 | | | |
| -TPU (Shore D hardness of 60) | | | | | 50 | | | | | 50 | | |
| TPu (Shore D hardness of 65) | | 25 | 75 | | | 50 | 25 | 75 | | | 50 | 25 |
| Lubricant-High molecular weight Polyester | 2 | | | | | | | 2 | 2 | 2 | 2 | 2 |
| Antioxidant Irgafos125) | | 0.8 | 0.8 | 0.8 | 0.8 | 0.8 | 0.8 | 0.8 | 0.8 | 0.8 | 0.8 | 0.8 |
| Antioxidant (IRGANOX 1010) | | 2 | 2 | 2 | 2 | 2 | 2 | 2 | 2 | 2 | 2 | 2 |
| Antioxidant (IRGANOX < MD1024) | | 1 | 1 | | | 1 | 1 | 1 | 1 | 1 | 1 | 1 |
| UV absorber (TINUVIN 1600) | | 1 | 1 | 1 | 1 | 1 | 1 | 1 | 1 I | 1 | 1 | 1 |
| Stabilizer (CYASORS 3529) | | 0.5 | 0.5 | 0.5 | 0.5 | 0.5 | 0.5 | 0.5 | 0.5 | 0.5 | 0.5 | 0.5 |
| Test Results | | | | | | | | | | | | |
| Processability assesment using metal detachment (3 good, 2 OK, 1 bad) | 3 | 1 | 1 | 1 | 1 | 1 | 1 | 1 | 3 | 3 | 3 | 2 |
| printability assessment using chrome [>199 good, 99-199 OK, <99 bad) | 177 | --- | --- | --- | --- | --- | --- | --- | 192 | 213 | 161 | 105 |
| Blocking assessment using T-Peel test {N/in} (>1.25 bad) | 0.24 | --- | --- | --- | --- | --- | --- | --- | 0.2 | 0.41 | 0.8 | 0.25 |

Examples 2C-7C demonstrate that the blends of acrylic core-shell polymer and TPUs are not calenderable without high molecular weight organic lubricant. Further, Example 8C is an example outside the required polymer blend, which exhibit poor calenderability. Examples 9-12 show examples within the required polymer blend, and with the required organic lubricant, which are calenderable and printable. Example 1C though exhibit comparative calenderability and printability performance, but fail at tear resistance and weatherability.

TABLE 2

Impact of flexible acrylic resin comprising block polymer

| Example No. (“C” indicates comparative example) | 13 | 14 | 15 | 16 | 17 | 18 | 19 | 20 | 21 | 22 | 23 |
|---|---|---|---|---|---|---|---|---|---|---|---|
| Flexible Acrylic Resin Block polymer PLAMA:BA (50:50) | 25 | 50 | 75 | 100 | 25 | 50 | 75 | | | 50 | 50 |
| Flexible Acrylic Resin Block polymer PMMA:BA (50:50) | | | | | | | | 50 | 75 | | |
| TPU (Shore D hardness of 93) | 75 | 50 | 25 | | | | | 50 | 25 | 50 | |
| TPU (Shore D hardness of 65) | | | | | 75 | 50 | 25 | | | | 50 |
| Lubricant -stearic acid High Mw Polyester | 2 | 2 | 2 | 2 | 2 | 2 | 2 | 2 | 2 | 2 | 2 |
| Antioxidant Irgafos126) | 0.3 | 0.8 | 0.8 | 0.8 | 0.8 | 0.8 | 0.8 | 0.8 | 0.8 | 0.8 | 0.8 |
| Antioxidant (IRGANOX 1010) | 2 | 2 | 2 | 2 | 2 | 2 | 2 | 2 | 2 | 2 | 2 |
| Antioxitant (IRGANOX MD1024) | 1 | 1 | 1 | 1 | 1 | 1 | 1 | 1 | 1 | 1 | 1 |
| UV absorber (TINUVIN 1600) | 1 | 1 | 1 | 1 | 1 | 1 | 1 | 1 | 1 | 1 | 1 |
| Stabilizer (CYASORS 3529) | 0.5 | 0.5 | 0.5 | 0.5 | 0.5 | 0.5 | 0.5 | 0.5 | 0.5 | 0.5 | 0.5 |
| Test Results | | | | | | | | | | | |
| Processability assessment using metal detachment {3 good, 2 OK, 1 bad) | 3 | 3 | 2 | 2 | 3 | 3 | 3 | 2 | 2 | 3 | 3 |
| Blocking assessment using T-Peel test (N/in) (>1.25 bad) | 2.8 | 0.14 | 0.07 | 0.08 | 0.1 | 0.08 | 0 | 0.3 | 0.11 | 0.2 | 0.1 |

Examples 13-23, show the results for block copolymers as the FAR within the required levels in the polymer blend. The polymeric blend with block acrylic copolymers exhibit good calenderability and blocking. The acrylic block polymers have similar biphasic chemistry as that of the core-shell acrylic resin and therefore perform in similar manner.

TABLE 3

Impact of amount of lubricant

| Example No. (“C” indicates comparative example) | 11 | 24 | 25 | 26 | 27 | 28 |
|---|---|---|---|---|---|---|
| Flexible Acrylic Resin Acrylic core-shell polymer | 50 | 25 | 50 | 50 | 50 | 75 |
| -TPU (Shore D hardness of 93) | | | 50 | | | |
| -TPU (Shore D hardness of 60) | | | | 50 | | |
| -TPU (Shore D hardness of 65) | 50 | 75 | | | 50 | 25 |
| Lubricant- High molecular weight Polyester | 2 | 4 | 4 | 4 | 4 | 4 |
| Antioxidant (Irgafos) 126) | 0.8 | 0.8 | 0.8 | 0.8 | 0.8 | 0.8 |
| Antioxidant (IRGANOX 1010) | 2 | 2 | 2 | 2 | 2 | 2 |
| Antioxidant (IRGANOX MD1024) | 1 | 1 | 1 | 1 | 1 | 1 |
| UV absorber (TINUVIN 1600) | 1 | 1 | 1 | 1 | 1 | 1 |
| Stabilizer (CYASORB 3529) | 0.5 | 0.5 | 0.5 | 0.5 | 0.5 | 0.5 |
| Test Results | | | | | | |
| Processability assessment using metal detachment (3 good. 2 OK, 1 bad) | 3 | 2 | 3 | 3 | 3 | 2 |
| Printability assessment using chroma, (>199 good, 99-199 OK, <99 bad) | --- | 243 | 201 | 185 | 242 | 245 |
| Blocking assessment using T-Peel test (N/in) (>1.25 bad) | 0.2 | 1.02 | 0.59 | 0.21 | 0.21 | 0.37 |

Examples 24-28 show the impact of an increased level of lubricant (4 phr v. 2 phr in Examples 24-28) on calendaring, but not at the expense of print and blocking.

TABLE 4

Impact of organic lubricant

| Example No. (“C” indicates comparative example) | 29 | 30 | 31 | 32 | 33 | 34 | 35 | 36 |
|---|---|---|---|---|---|---|---|---|
| Flexible Acrylic Resin- core-shell polymer | 50 | 50 | 50 | 50 | 50 | 50 | 50 | 50 |
| TPU (Shore D hardness of 93) | 50 | | | 50 | | | | |
| TPU (Shore D hardness of 60) | | 50 | | | 50 | | | |
| TPU (Shore D hardness of 65) | | | 50 | | | 50 | 50 | 50 |
| Lubricant- Fatty (Stearic) Acid | 1 | 1 | 1 | | | | | |
| Lubricant- Fatty (Hydroxystearic) Acid | | | | 1 | 1 | 1 | | |
| Lubricant-high-mono glycerol monostearate | | | | | | | 1 | |
| Lubricant- Stearic Acid high Mw polyester | | | | | | | | 1 |
| Antioxidant (Irgados 126) | 0.8 | 0.8 | 0.8 | 0.8 | 0.8 | 0.8 | 0.8 | 0.8 |
| Antioxidant (IRGANOX 1010) | 2 | 2 | 2 | 2 | 2 | 2 | 2 | 2 |
| Antioxidant (IRGANOX MD 1024) | 1 | 1 | 1 | 1 | 1 | 1 | 1 | 1 |
| UV absorber (TINUVIN 1600) | 1 | 1 | 1 | 1 | 1 | 1 | 1 | 1 |
| Stabilizer (CYASORB 3529) | 0.5 | 0.5 | 0.5 | 0.5 | 0.5 | 0.5 | 0.5 | 0.5 |
| Test Results | | | | | | | | |
| Processability assessment using metal detachment (3 good, 2 OK, 1 bad) | 2 | 2 | 3 | 2 | 2 | 3 | 3 | 3 |
| Printability assessment using chroma (>199 good. 99-199 OK, <99 bad) | 99 | 202 | 229 | 130 | 111 | 233 | 128 | 122 |
| Blocking assessment using T-Peel test (N/in) (>1.25 bad) | 0.34 | 1.36 | 1.83 | 0.19 | 0.14 | 2.88 | 0.59 | 0.22 |

Examples 29-36 show that other organic lubricants work beyond oleic acid high Mw polyester of glycerine for calendaring, and still do not hinder printability, although blocking can be an issue and require an interleaf sheet.

TABLE 5

Impact of inorganic lubricant

| Example No. {“C” indicates comparative example) | 37C | 38C | 39C | 40C | 41C | 42C | 43C | 44C |
|---|---|---|---|---|---|---|---|---|
| 39F40l41exible Acrylic Resin (core-shell polymer) | 100 | 25 | 25 | 25 | 50 | 50 | 50 | 75 |
| TPU (Shore D hardness of 93) | | 75 | | | 50 | | | |
| TPU (Shore D hardness of 60) | | | 75 | | | 50 | | 25 |
| TPU (Shore D hardness of 65) | | | | 75 | | | 50 | |
| Lubricant Inorganic (barium stearate + zinc stearate) | 1 | 1 | 1 | 1 | 1 | 1 | 1 | 1 |
| Antioxidant (Irgefos 126) | 0.8 | 0.8 | 0.8 | 0.8 | 0.8 | 0.8 | 0.8 | 0.8 |
| Antioxidant (IRGANOX 1010) | 2 | 2 | 2 | 2 | 2 | 2 | 2 | 2 |
| Antioxidant (IRGANOX MD1024) | 1 | 1 | 1 | 1 | 1 | 1 | 1 | 1 |
| UV absorber (TINUVIN 1600) | 1 | 1 | 1 | 1 | 1 | 1 | 1 | 1 |
| Stablitzer (CYASORB 3529) | 0.5 | 0.5 | 0.5 | 0.5 | 0.5 | 0.5 | 0.5 | 0.5 |
| Test Results | | | | | | | | |
| Processability assessment using metal detachment (3 good, 2 OK, 1 bad) | 3 | 1 | 1 | 2 | 3 | 3 | 3 | 2 |
| Printability assessment using chroma (>199 good, 99-199 OK. <99 bad) | 30 | --- | --- | 61 | 65 | 43 | 125 | 22 |
| Blocking assessment using T-Peel test (N/in) (>1.25 bad) | 0.46 | --- | --- | 1.56 | 0.33 | 0.28 | 5.02 | 0.45 |

Examples 37C-44C show that inorganic lubricants cause printability issues and some blocking issues.

TABLE 6

Impact of pigment

| Example No. (“C” indicates comparative example) | 45 | 46 | 47 | 48 | 49 | 50 | 51 |
|---|---|---|---|---|---|---|---|
| Flexible Acrylic Resin (core-shell polymer) | 50 | 75 | 100 | 50 | 75 | 50 | 75 |
| TPU (Shore D hardness of 65) | 50 | 25 | | 50 | 25 | 50 | 25 |
| Lubricant- Oleic Acid high Mw polyester | | | 2 | 2 | 2 | | |
| Lubricant- Glycerol Ester | | | | | | 2 | 2 |
| Antioxidant (Irgator 126) | 0.8 | 0.8 | 0.8 | 0.8 | 0.8 | 0.8 | 0.8 |
| Antioxidant (IRGANOX 1010) | 2 | 2 | 2 | 2 | 2 | 2 | 2 |
| Antioxidant (IRGANOX MD1024) | 1 | 1 | 1 | 1 | 1 | 1 | 1 |
| UV absorber (TINUVIN 1600) | 1 | 1 | 1 | 1 | 1 | 1 | 1 |
| Stabilizer (CYASORB 3529) | 0.5 | 0.5 | 0.5 | 0.5 | 0.5 | 0.5 | 0.5 |
| Pigment (titanium dioxide) | 20 | 20 | 20 | 20 | 20 | 20 | 20 |
| Test Results | | | | | | | |
| Processability assessment using metal detachment (3 good, 2 OK, 1 bad) | 1 | 1 | 3 | 2\| | 2 | 2 | 2 |
| Printability assessment using chroma (>199 good, 99-199 OK, <99 bad) | --- | --- | 296 | 221 | 223 | 280 | 159 |
| Blocking assessment using T-Peel test (N/in) (>1.25 bad) | --- | --- | 0.61 | 0.37 | 0.48 | 0.98 | 1.08 |

Examples 45-51 show pigmented formulations for films with the required organic lubricant and the required FAR and TPU levels in the polymer blend.

TABLE 7

Impact of Calcium Carbonate

| Example No. “C” indicates comparative example) | 52C | 53C | 54C | 55C | 56 | 57 | 58 | 59 | 60 | 61 |
|---|---|---|---|---|---|---|---|---|---|---|
| Flexible Acrylic Resin (Core-shell polymer) | 25 | 50 | 75 | 100 | 25 | 50 | 75 | | | 50 |
| TPU (Shore D hardness of 93) | 75 | 50 | 25 | | | | | 50 | 25 | 50 |
| TPU (Shore D hardness of 65) | | | | | 75 | 50 | 25 | | | |
| Calcium Carbonate (1.3 µm) | 10 | 10 | 10 | 10 | | | | | | |
| Lubricant-Oleic acid High Mw Polyester | | | | 4 | 4 | 4 | 2 | 3 | 4 | 5 |
| Lubricant Inrorganic (barium stearate + zinc strlate) | 1 | | 1 | | | | | | | |
| Antioxidant (Irgefos 126) | 0.8 | 0.8 | 0.8 | 0.8 | 0.8 | 0.8 | 0.8 | 0.8 | 0.8 | 0.8 |
| Antioxidant (IRGANOX 1010) | 2 | 2 | 2 | 2 | 2 | 2 | 2 | 2 | 2 | 2 |
| Antioxidant (IRGANOX MD1024) | 1 | 1 | 1 | 1 | 1 | 1 | 1 | 1 | 1 | 1 |
| UV absorber (TINUVIN 1600) | 1 | 1 | 1 | 1 | 1 | 1 | 1 | 1 | 1 | 1 |
| Stabilizer (CYASORB 3529) | 0.5 | 0.5 | 0.5 | 0.5 | 0.5 | 0.5 | 0.5 | 0.5 | 0.5 | 0.5 |
| Pigment (titanium dioxide) | | | 20 | 20 | 20 | 20 | 20 | 20 | 20 | 20 |
| Test Results | | | | | | | | | | |
| Processability assessment using metal detachment (3 good. 2 OK, 1 bad) | 3 | 1 | 1 | 1 | 3 | 3 | 2 | 2 | 3 | 3 |
| Printability assessment using chroma (>199 good, 99-199 OK, <99 bad) | 36 | --- | --- | --- | 349 | 123 | 212 | 163 | 322 | 248 |
| Blocking assessment using T-Peel test (N/in) (>1.25 bad) | 0.31 | --- | --- | --- | 0.43 | 1.23 | 0.68 | 0.73 | 0.62 | 0.83 |

Examples 52C-55C are comparative examples showing how calcium carbonate alone blocks, while the lubricant and calcium carbonate combinations do not show printability for all acrylics, and are not calenderable in blends. Examples 56 and 58 are examples of the invention. Examples 59-61 show a ladder of the level of lubricant, where the metal detachment improves, but not at the expense of printability and T-Peel.

When ranges are used herein for physical properties, such as molecular weight, or chemical properties, such as chemical formulae, all combinations, and sub-combinations of ranges are intended to be included.

The disclosures of each patent, patent application, and publication cited or described in this document are hereby incorporated herein by reference, in their entirety.

Those skilled in the art will appreciate that numerous changes and modifications can be made to the embodiments of the invention, and that such changes and modifications can be made without departing from the spirit of the invention. It is, therefore, intended that the appended claims cover such equivalent variations that fall within the true spirit and scope of the invention.

What is claimed is:

1. A film, comprising a polymeric blend,
the polymer blend comprising:
50% by weight to 100% by weight, based on the total weight of the blend, of a flexible acrylic resin;
0% by weight to 50% by weight, based on the total weight of the blend, of a thermoplastic urethane elastomer;
0.1% to 10% by weight, based on the total weight of the blend, of a high molecular weight organic lubricant; and
optional pigment;
wherein the film is both processable and printable.

2. The film of claim 1, wherein the flexible acrylic resin is at least one of block copolymer, and multi-stage polymer.

3. The film of claim 1, wherein the flexible acrylic resin is a multi-stage acrylic polymer comprising:
a core layer comprising the cross-linked residues of a low Tg monomer selected from the group consisting of butyl acrylate, 2-ethylhexyl acrylate, and combinations thereof;
an optional intermediate layer; and
a shell layer comprising a methacrylate polymer having a glass transition temperature of above 100° C.

4. The film of claim 1, wherein the flexible acrylic resin is present in an amount in the range of from 50% by weight to 95% by weight, based on the total weight of the blend.

5. The film of claim 1, wherein the flexible acrylic resin has a Shore D Hardness of from about 40 to about 60.

6. The film of claim 1, wherein the thermoplastic urethane elastomer is selected from the group consisting of polyether based polyurethane, polyester based polyurethane, polycarbonate based polyurethane and combinations thereof.

7. The film of claim 1, wherein the thermoplastic urethane elastomer is present in an amount in the range of from 5% by weight to 50% by weight, based on the total weight of the blend.

8. The film of claim 1, wherein the thermoplastic urethane elastomer has a Shore D Hardness of about 55 to about 95.

9. The film of claim 1, wherein the thermoplastic urethane elastomer has a Shore D Hardness of at least 65.

10. The film of claim 1, wherein the high molecular weight organic lubricant is a high molecular weight polyester lubricant.

11. The film of claim 10, wherein the high molecular polyester is the reaction product of a fatty acid selected from the group consisting of oleic acid, stearic acid, hydroxystearic acid, and combinations thereof and an alcohol selected from the group consisting of butanol, octanol, glycerol, pentaerythritol, and combinations thereof.

12. The film of claim 1, wherein the high molecular weight organic lubricant is present in an amount in the range of from 1% to 5% by weight, based on the total weight of the blend.

13. The film of claim 1, wherein the high molecular weight organic lubricant has a molecular weight of at least about 1,500 Da.

14. The film of claim 13, wherein the high molecular weight organic lubricant has a molecular weight of at least about 1,500 Da to about 50,000 Da.

15. The film of claim 1, wherein the pigment is present and is titanium dioxide.

16. The film of claim 1, wherein the polymeric blend further comprises no more than 1% by weight, based on the total weight of the blend, of a filler.

17. The film of claim 1, wherein the polymeric blend comprises less than 0.75% by weight, based on the total weight of the blend, of a filler; and wherein the filler is calcium carbonate.

18. The film of claim 1, wherein the polymeric blend comprises less than 0.075% by weight, based on the total weight of the blend, of an organic acid metal salt.

19. The film of claim 18, wherein the organic acid metal salt is a salt selected from the group consisting of barium stearate, zinc stearate, and combinations thereof.

20. The film of claim 1, wherein the polymeric blend does not contain calcium carbonate.

21. The film of claim 1, wherein the polymeric blend does not contain an organic acid metal salt.

22. The film of claim 1, wherein the polymeric blend does not contain a hydrogen-bondable monomer.

23. The film of claim 1, wherein the film has a thickness of from 30 µm to 200 µm.

24. The film of claim 1, wherein the film is calendered.

25. An article, comprising the film of claim 1, wherein
the film has a first face and a second face;
an adhesive layer is applied to at least a portion of the first face of the film;
an optional printed indicia is applied to at least a portion of the second face of the film; and
an optional release layer is applied on the adhesive layer.
